(19) United States
(12) Patent Application Publication
(10) Pub. No.: US 2002/0176806 A1
(43) Pub. Date: Nov. 28, 2002

(54) Application of a disposable tube in biomedical and immunological assays

(76) Inventors: Weiping Ren, Troy, MI (US); Juan Jie Ren, Troy, MI (US)

Correspondence Address: Mr. Weiping Ren, 1289 Kirts Blvd., #63, Troy, MI, 48084, US

(21) Appl. No.: 10/102,054

(22) Filed: Mar. 21, 2002

Related U.S. Application Data
(60) Provisional application No. 60/278,330, filed on Mar. 26, 2001.

(51) Int. Cl. B01L 3/00

(52) U.S. Cl. 422/102; 422/99; 422/61; 435/283.1; 435/287.2; 435/288.1

(57) ABSTRACT

The present invention provides a disposable tube that represents a low-cost and convenient container for the liquid aliquots of biological and immunological reagents, such as monoclonal antibodies, purified enzymes, for use in the determination of various components from biological sources. The disposable tube is composed of plastic material with sealed liquid aliquots inside. This tube can be opened by the rupture of both sealed ends right before use. The present invention relates to a new “ready for use” tube and relevant kit(s) that can be used in various kind of biochemical, immunological analysis including, but not limited to, immunohistochemical and immunocytochemical staining, immunoprecipitation, western blot, enzyme activity analysis, in the determination of various components from biological sources. A relevant prototype of “Leukocyte Immunophenotyping Kit” is also described.

RELATED APPLICATION

This application claims the benefit of U.S. Provisional Application Ser. No. 60/278,330 filed Mar. 26, 2001, which is incorporated herein in its entirety by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to disposable plastic tubes that represent a low-cost and convenient container for the liquid aliquots of biological reagents for use in the determination of various components from biological sources. The disposable tube is composed of plastic material with sealed liquid aliquots inside. This tube is open-able by the rupture of both sealed ends right before use. More particularly, the present invention relates to a disposable tube and relevant kit(s) that can be used in various kind of biochemical, immunological analysis including, but not limited to, immunohistochemical staining, immunoprecipitation, western blot, and enzyme activities. A prototype of “Leukemia Immunophenotyping Kit” using present invention is also described. The present invention can save precious biological reagents required for biological and immunological assays.

2. Description of the Related Art

Over the last few years, biological and immunological assays have been extensively used in the field of both biomedical research and clinical diagnosis, especially with the explosion of commercial available antibodies and other biomedical reagents. One of the problems in the popularization and development of these technologies is the waste of unused “expired reagents”. For example, primary antibodies, especially monoclonal antibodies, are usually expensive with an average price of $100 to $300 for the smallest package (0.1 mg to 0.2 mg). This amount of antibody is usually enough for staining a few hundreds to thousands slides in immunohistochemistry approach (IHC). In view of the limited shelf life of these biomedical reagents, especially those from protein origin, (antibodies, enzymes, et al.), waste of unused “expired reagents” represents a common problem in the biomedical and clinical field.

It is also the fact that the increased pricing for various kinds of biological assays includes the significant cost(s) from the waste of these precious reagents. It has become a financial burden to both patients and medical insurance companies. It is also undesirable for the biomedical researchers, especially for those who have limited grant supports. This factor, combined others, has prevented the further promotion and development of many novel biomedical analysis technologies.

Therefore, there still remains a need in the art for an inexpensive, disposable assay tube for reserve the aliquots reagents, that can be fully used during the analysis.

The present invention can be a part of solution to this problem. Using this disposable tube, we can do various kinds of biomedical and immunological analysis on an individual case basis. The advantages of this invention include (1) Decrease the ratio of cost per test by avoiding the waste of precious reagents; (2) User friendly. As described in the prototype of “Leukemia Immunophenotyping kit”, entire immunocytochemical staining procedure has been optimized for the best results. The present invention can meet the needs of the field professionals both in clinical and basic life science laboratories. In addition, the present invention can assist manufacturers, suppliers and distributors of biological reagents to expend their market volume and sales at the lowest entry price.

3. Relevant Patents

U.S. Pat. No. 6,120,733 discloses a self-contained disposable assay device, which is capable of detecting various analytes from biological sources by the use of a specific binding pair, such as antibody/antigen, polynucleotide/complementary polynucleotide, ligand/receptor, enzyme/substrate and enzyme/co-factor, etc.

U.S. Pat. No. 5,169,789 discloses a self-contained solid phase immunodiffusion assay containing a tube having a sample collector and compartmentalized reagents separated by seals that can be broken through pressure on the sample collector, mixed with reagent, and pushed into a ligand receptor reaction area.

U.S. Pat. No. 4,857,453 discloses a device for conducting an immunoassay containing a means in the housing for introducing a sample into the device and a self-contained liquid reagent in a breakable container.

U.S. Pat. No. 4,859,421 discloses a disposable antigen concentrator and detector containing a reagent storage chamber connected to the reaction chamber through a valve means, which allows fluid flow from the reagent chamber to the reaction chamber.

U.S. Pat. No. 5,137,808 discloses a liquid reagent in a breakable container utilized for the determination of an analyte in a sample, and liquid reagents in a container, which pass into a second container when a seal is ruptured.

U.S. Pat. No. 5,147,780 discloses an apparatus for the detection of analytes containing a liquid medium restrained from a sample-absorbing nib by a frangible barrier that is broken allowing the nib to drop into the liquid medium.

U.S. Pat. No. 4,769,333 discloses a personal, disposable hand held diagnostic kit having specimen support member. The specimen support member carries a plurality of receptacles for containing liquid materials. The receptacles are later cut in sequence to release the liquid.

U.S. Pat. No. 4,608,231 discloses a self-contained reagent package device containing a plurality of wells in the support member.

U.S. Pat. No. 4,859,419 discloses an apparatus for immunoassay of multiple samples of biological fluids containing a frame having plural test vessels.

U.S. Pat. No. 4,981,786 discloses a multiple port assay device containing a housing means for capturing a first member of a specific binding pair in a zone and for allowing liquid to be transported by capillary action away from the zone.

U.S. Pat. Nos. 4,978,504 and 5,078,968 disclose a specimen test unit containing a specimen collecting swab and a reagent-containing ampoule in cylindrical housing that can be bent or squeezed or otherwise deformed to fracture a reagent-containing ampoule.

U.S. Pat. No. 5,137,808 discloses a liquid reagent in a breakable container utilized for the determination of an analyte in a sample, and liquid reagents in a container, which pass into a second container when seal is ruptured.

There still remains a need in the art for an inexpensive, disposable assay tube for reserve the aliquots reagents, that can be fully used during the analysis. The present invention provides such an economical, compact, easy to operate assay tube to reserve biological reagents.

4. Applicable U.S. patent Classification Definitions 604/3; 436/1; 436/517; 436/535; 436/540; 436/548; 436/30; 436/37; 436/46; 436/63; 436/176; 436/179; 436/180; 436/810; 435/30; 435/5.1; 43515.2; 4351286.4; 4351960; 435/286.5; 435/287.3; 435/287.6; 435/288.1; 435/288.3; 435/288.5; 435/290.4; 435/299.2; 435/304.1; 422/30; 422/40; 422141; 422/61; 422/100; 422/102; 422/201; 422/914; 422/916; 422/936; 422/937;

### BRIEF SUMMARY OF THE INVENTION

It is an object of this invention to construct a disposable tube that contains a sealed quantity of biochemical and immunological reagents. These reagents can be either concentrated or diluted antibodies, enzymes, substrates that can be brought together when needed. The present invention relates to a design to keep the precious reagents being fully used without waste, so the cost for per test will be significantly decreased.

This is another object of this invention to make it possible of doing biomedical analysis on individual test basis. Ideally, such a sealed tube would be easy to carry and use friendly. This tube is disposable and contains the reagent in an amount enough for the tests required. Furthermore, the tube size can be adjusted according to the analysis type and sample size.

It is a further object of this invention to provide an improved device that can be used for various kinds of biological and immunological assays including, but not limited to, immunohistochemical and immunocytochemical staining, western blot, ELISA assay, microbiology analysis and all other kinds of biochemical analysis.

These disposable tubes can be used alone or included in any kinds of assay kits. Furthermore, it is another object of this invention to design the immunological staining that multiple antibodies could be used in group on the different assay regions of the same slide.

It is further the object of the present invention to be used by manufacturers, suppliers, and distributors of biological and immunological reagents to promote sales and meet customer's increasing needs. For example, manufacturers can send their potential customers these disposable tubes with ready-to use sample reagents inside for evaluation purpose at a much lower promotional cost. Most important, they also can manufacture and sell their precious reagents using this invention to meet customer's special need.

Another objective of this invention is to provide not only a disposable tube but also extend to any other kind of small disposable containers such as bottle, dish, bag etc. These containers should be easily transportable, capable of carrying biological reagents inside and easily to be opened and disposable after use.

For clarity and not by way of limitation, the present invention is described in terms of an immunocytochemical process.

It will be clear to one of ordinary skill in the art that the improved steps of the present invention can be used in other biochemical and immunological analysis. Some of the reagents and steps are applicable to any small volume assay involving critical reagent use. It is to be understood that the present invention is capable of variation and modification. Accordingly, such changes and alterations are properly intended to be within the full range of equivalents, and therefore within the purview of the listed claims. The various aspects, advantages and features of the present invention will become apparent to, and more fully understood by, those skilled in the art by reference to the accompanying figures that are provided for this purpose.

### BRIEF DESCRIPTION OF THE DRAWINGS

These and other features, aspects, and advantages of the present invention will become much more apparent from the following description and accompanying drawings, it being understood that the invention is not intended to be limited to the precise arrangements, and instrumentation shown in which:

FIG. 1 (A-B) is a plan view of the disposable tube for reserving the liquid aliquots of precious reagents such as monoclonal or polyclonal antibodies. FIG. 1a shows the length of the tube and the sealed end at both sides. FIG. 1b shows one sealed end. As seen in FIG. 1, this sealed tube reserves 50 μl of ready-to-use antibody solution inside. The antibody solution can be stable inside for 6-12 months. Right before use, both sealed ends will be cut by a scissor, and the solution inside will be pushed out and applied right on the assay region of a slide (immunological staining).

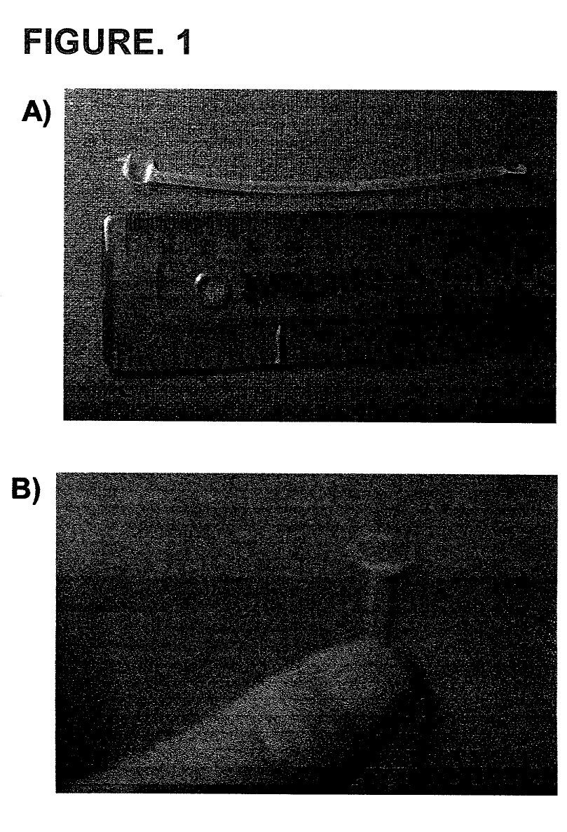

FIG. 2(A-C) is a description of rupture of tube's sealed ends. FIG. 2a shows the cutting of one sealed end. FIG. 2b shows cutting the other sealed end. FIG. 2c shows a tube with both sealed ends cut.

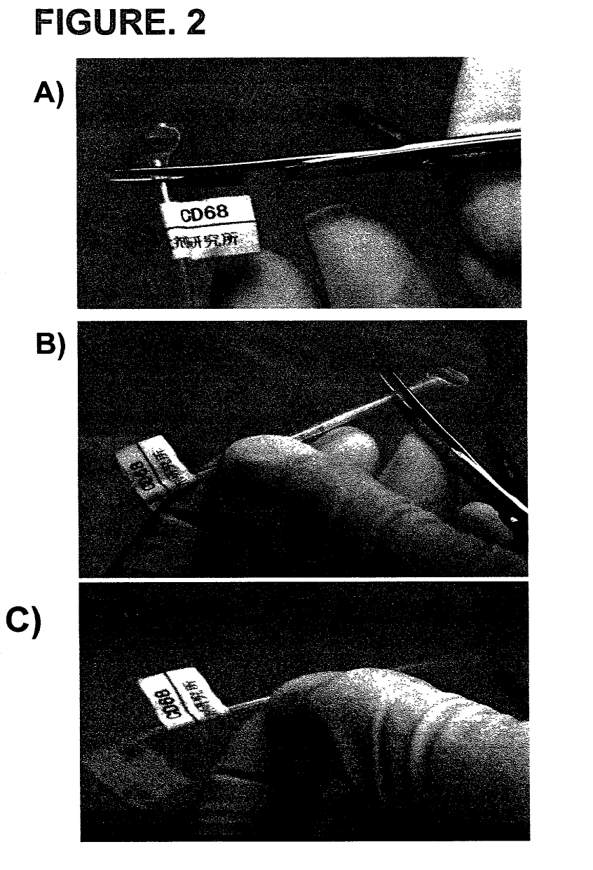

FIG. 3 shows the process of loading the liquid aliquots from the tube to the assay region of tissue section. FIG.3a shows how to mark the assay region of a slide (the region containing tissue or cell section) using a diamond pen. The liquid aliquots will be applied into this marked assay region; usually antibody solution at the amount of 50 μl is sufficient to cover this around 5-mm² area. FIG. 3b shows that the liquid aliquots is removed from the tube and applied directly on the assay region of a slide using a pipette. FIG. 3c shows an assay region of a slide covered with liquid aliquots from the tube. Alternatively, the liquid aliquots can be removed from the tube by using a small rubber ball that can be attached to one end of the tube. This rubber ball can be reusable and included in the assay kit(s).

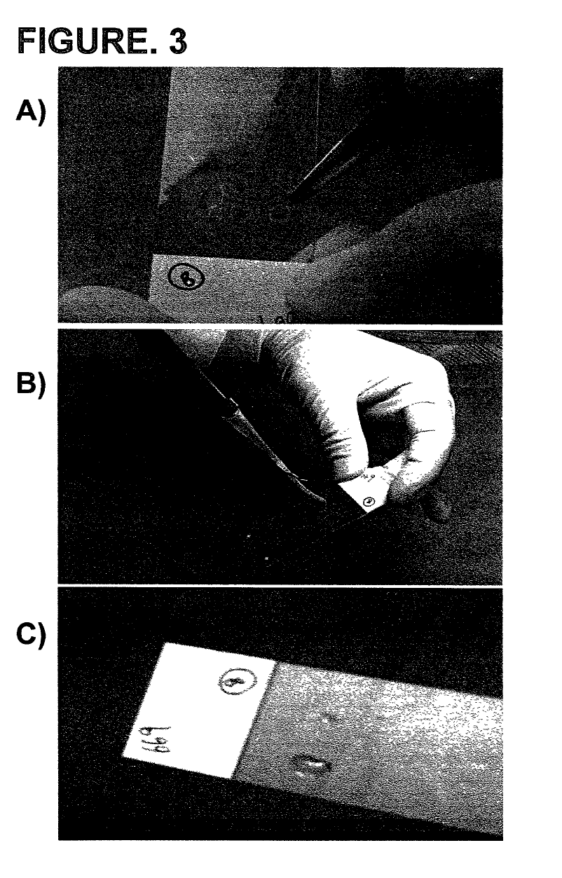

FIG. 4. Prototype of “Leukemia Immunophenotyping kit”. For this analysis, five different leukocyte cell surface markers will be determined and this analysis is a requirement for diagnosis and differential diagnosis of patients with leukemia. FIG. 4a discloses the design of this kit package. The label shows (Translation from Chinese language) “Leukemia immunophenotyping kit”. FIG. 4b show the contents of this kit. It includes: (1) Five sealed tubes containing five pre-diluted monoclonal antibodies (50 μl each) are combined and stored in a plastic bag; (2) Four small bottles include all ready-for-use reagents including fixative, concentrated washer solution; enzyme conjugated secondary antibody and substrate solution.

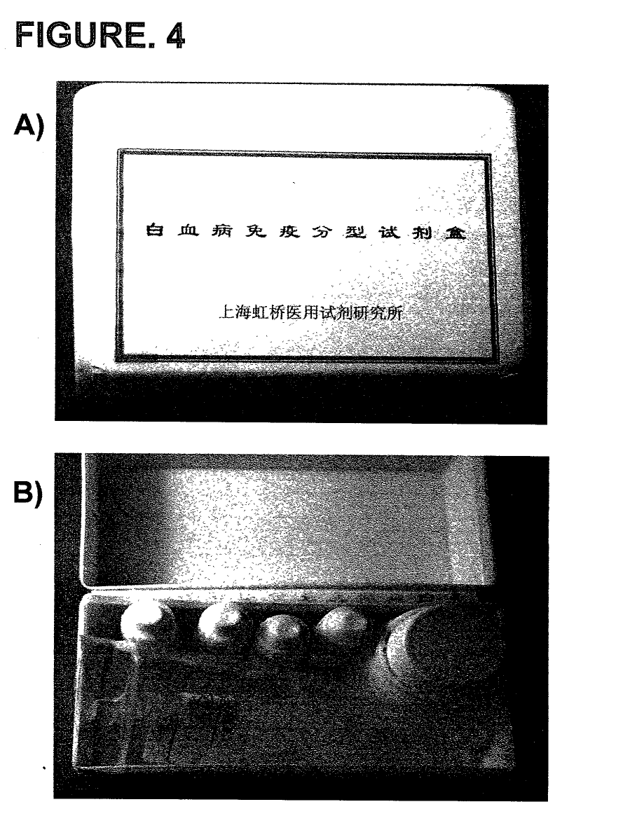

FIG. 5 is the extension disclosure of FIG. 4. FIG. 5a shows the five separate sealed tubes containing 50 μl of individual monoclonal antibodies (2 μg/ml) monoclonal antibodies. Sticker labels are affixed to these tubes, showing CD3, CD68. CD33, CD20 and MPO, separately. FIG. 5b shows that these five tubes are sealed in a plastic bag for shipment.

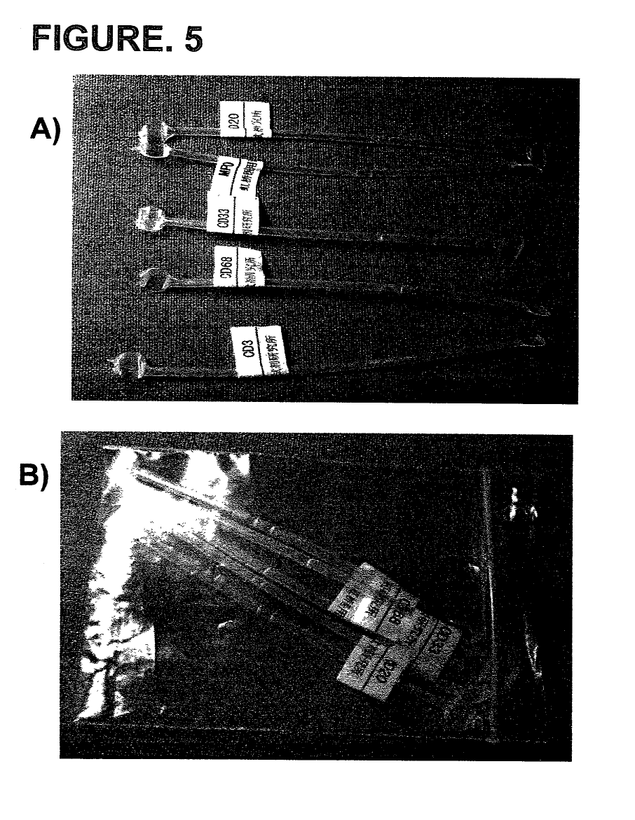

FIG. 6 shows the other components disclosed in FIG. 4, that immunological staining assay requires, including: (a) fixative (1 ml); (2) enzyme-conjugated secondary antibody (0.5ml); (3) concentrated wash solution (1:20 PBS concentrate); and 4) ready for use substrate solution (0.5 ml). (Translation from Chinese language)

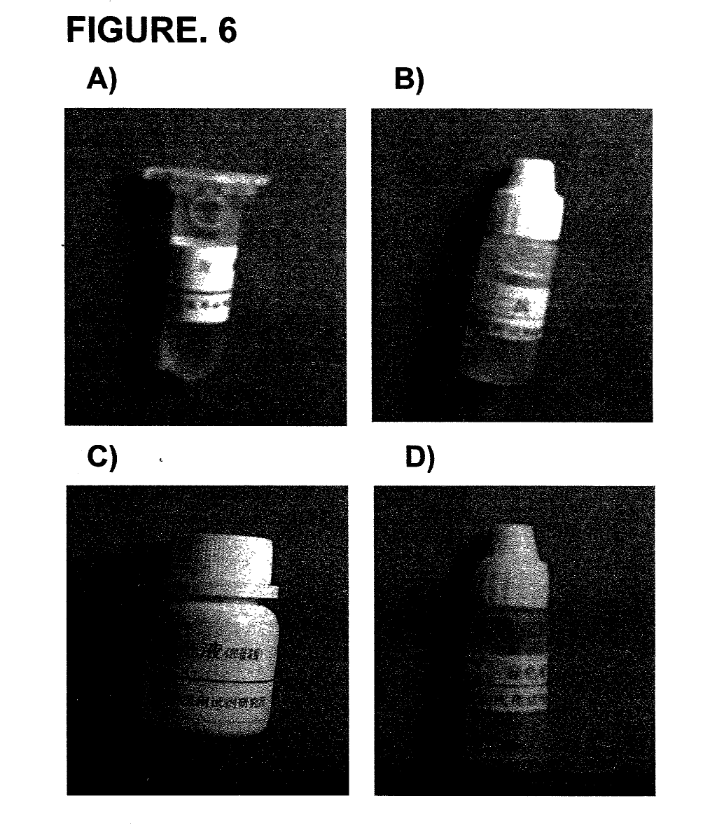

### DRAWINGS

FIGS. (1 to 6) are included.

### DETAIED DESCRIPTION OF THE INVENTION

1. Characterization of Tube Material

The disposable tube is made from the highest-grade resins and special plasticizers. These tube materials are usually thermoplastic, transparent, flexible, and shatterproof. The tube materials are commercial available (VWR Scientific Products Catalog, 2001), including (i) # 60985-502 (T1800) PVC tubing 50′, 1/16×⅛ Autoclavable; (ii) # 63013-541 (T1802) Clear PVC tubing 50′, 1/16×⅛ Autoclavable, and (iii) # 63014-710 (T1805) Teflon FEP tubing, Nalgene 50′, 1/16×⅛ Autoclavable, superior non-stick. These tube materials will be autoclavable and have a super non-stick property surface to minimize protein binding/adsorption to the tube surface.

2. Design of the Disposable Tube

The disposable tubes with different size and lengths will be designed based on actual need. For example, a tube with the interior diameter of ⅛″ will be suitable for storage of primary antibodies at the amount from 50 μl to 500 μl. The assay tube will be sterilized by autoclave treatment (for most kinds of plastic tubes). Alternatively, a brief exposure to γ-irradiation (20-100 krad) can be used for sterilization right before use. Then the assay tube will be cut at different length ranges from 3 cm to 10 cm or longer according to the analysis type and sample size, et al. In the sample presentation, the interior diameter of this tube is ⅛′. This kind of tube is suitable for carry various kinds of reagents at the amount ranging from 50 μl to 500 μl.

Before adding liquid aliquots, one end of the tube will be sealed by laboratory sealing machine. After one end is sealed, the liquid aliquots of biological reagents can be added to this tube by using pipetter. The other end of the tube can then be sealed in the same way. A sticker indicating the concentration and nature of the liquid aliquots can be affixed to this tube. The tube with sealed liquid aliquots can be stored in the refrigerator. The shelf life and storage condition will be different in view of the nature and stability of various kinds of biological and immunological reagents. The liquid aliquots will be either antibodies or other reagents that can be prepared at the format of ready-for-use and at the amount that can meet specified biological analysis.

3. Prototype kit-Leukemia immunophenotype kit

The disposable tube can be used for various types of biochemical and immunological assays. To better understand the usage of this tube, we represent here a prototype “Leukemia immunophenotyping kit” for demonstration purpose. Please also refer to the sections of Brief Description to the drawings and Drawings for more detail. Principle

The principle of this immunological staining is as follows: Using a panel of primary antibodies specifically targeted to the antigens of interest on the bone marrow smear section, wherein said CD3, CD11, CD20, CD68 and MPO, to form the initial antigen-antibody complex. An enzyme-conjugated antibody, referred to as a secondary antibody, which is specific for the species of the primary antibody, (in this case, mouse) is then used to detect the primary antibody. When the label is an enzyme, the substrate is added to detect the complex. In this way, a variety of primary antibodies produced in the same animal species can be used with a single labeled secondary antibody for visualization.

Description

A panel of five pre-diluted (2 μg/ml) monoclonal antibodies targeted against leukocyte cell surface markers (CD3, CD11, CD20, CD68 and MPO) were storied in five separate disposable tubes at the amount of 50 μl, an amount sufficient to cover one assay region of the slide. Bone marrow smear slides were washed with PBS and then incubated with these mouse monoclonal antibodies. An enzyme-conjugated secondary antibody (Envision system, Dako), which is specific for the species (mouse) of the primary antibody, was then used to detect the primary antibody. The color was then developed by adding 3,3″-diaminobenzidine tetra hydrochloride dihydrate (DAB) substrate.

Rationale

Using this prototype kit, hematologists will no longer worry about the waste of unused “expired antibodies”. Although this prototype kit was based on individual slide basis, the kit/assay tube size can be adjusted at the customer's request ranged from 5 to 100 assays. In contrast to other commercial available immunohistochemical or immunocytochemical staining kits, only tiny amount of monoclonal antibody (100 ng) was included in each assay tube, so the cost of this kit is dramatically decreased while high quality of staining is guaranteed. The cost factor will be more significant when a panel of primary antibodies was required and the sample size is relatively limited.

Kit contents

| | |
|---|---|
| Fixative solution (ready to use) cold acetone | 10 ml |
| 3% H₂O₂ | 1 ml |
| Primary Antibody | 50 μl/per tube × 5 |
| | (ready to use) |
| Second antibody (Dako Envision system) | 0.5 ml (ready for use) |
| Substrate | one vial |
| Substrate buffer | 0.5 ml/vial |
| Washing solution (1:20 concentrate) | 30 ml/bottle |

Staining procedure

a) Prepare the bone marrow smear slide ready. The slide is briefly fixed for 90 seconds at 4° C. using the fixative provided by the kit.

b) Wash out the fixative and let the slide briefly dried.

c) Mark 5 well separated assay region (around 5 mm² each) on the bone marrow smear slide.

d) Cut both ends of the tube using a scissors, and then the liquid aliquot of diluted antibody is removed outside of the tube and directly applied to the pre-marked field of slide section using a pipette attached with a yellow tip. Fifty (50) μl is sufficient to cover 5-mm² surfaces.

e) Repeat step 2 until all five primary antibodies have been loaded to corresponding section field. Make sure each field is fully emerged in the antibody solution and not mixed with each other. Slide is then incubated in a humidified chamber at room temperature for 60 min.

f) After incubation, slides are washed with PBS and a few drops of enzyme-conjugated secondary antibody are applied to each assay field. Incubate in a humidified box for another 30 min.

g) After washing with PBS, a few drops of substrate solution are added. It usually takes 3-5 minutes for color development. Washing with distilled water terminates the reaction.

| Staining | Indication |
|---|---|
| MPO (+) (Cytoplasm) | Acute non-lymphocyte leukemia |
| CD33 (+) (membrane) | Acute early leukocyte leukemia |
| CD68 (+) (membrane) | Acute monocyte leukemia |
| CD3 (+) (membrane) | Acute T lymphocyte leukemia |
| CD20 (+) (membrane) | Acute B lymphocyte leukemia |

This easy-to-use prototype kit provides reliable, consistent results for the leukemia immunophenotype staining. In contrast to other commercial available similar ready-for-use Immunological staining kits, only tiny amount of individual monoclonal antibody (100 ng each) is included in this kit by being stored in the disposable tube, so the cost of the assay is decreased. The cost factor will be more significant in those situations that more than one primary antibody is required and the sample size is relatively limited.

I claim:

1. A disposable plastic tube with both ends sealed preserves liquid aliquots of biological and immunological reagents.

2. The tube of claim 1 wherein said the plastic tube is made from the highest-grade resins and special plasticizers. These tube materials are usually thermoplastic, transparent or opaque, flexible, and shatterproof.

3. The tube of claim 1 wherein said sealed ends are prepared by melting the end of the tube by commercial available sealing machine.

4. The tube of claim 1 wherein said liquid aliquots can be any kinds of biological and immunological reagents, such as antibodies of human or animal origin or binding fragments, enzymes, substrates, standard proteins, etc. These reagents can be stored in the form of either pre-diluted or concentrated.

5. The tube of claim 1 wherein said the tube can be sterilized by autoclave treatment or by brief UV light exposure before use.

6. The tube of claim 1 wherein said the length of tube is about 8 cm. However, the length can be adjusted according to the amount of liquid aliquots being stored.

7. The tube of claim 1 wherein said the inner diameter of the tube is 1/16′ to ⅛′. However, the inner diameter of this tube can be adjusted according to the actual need

8. The tube of claim 1 wherein said the amount of liquid aliquots ranges from a few micro liter (μl) up to a few milliliter (ml). The amount of liquid aliquots will be adjusted in view of the analysis type, test volume and sample size etc. For example, less than 50 μl of pre-diluted antibody will be sufficient to cover an assay region of a slide section in an immunological staining approach.

9. The tube of claim 1 can be used in immunohistochemical and immunocytochemical staining.

10. The tube of claim 1 can be used in western blot analysis.

11. The tube of claim 1 can be used in immunoprecipitation analysis.

12. The tube of claim 1 can be used in microbiology analysis.

13. The tube of claim 1 can be used in ELISA analysis.

14.The tube of claim 1 can be used in molecular, cell biology, and biochemical assays, include, but not limited to, enzyme activity, receptor assays, Ligand assay, cell proliferation assay, DNA damage detection, protein quantification, SOD and cytotoxicity assays.

15. The tube of claim 1 can be used in various kinds of immunological analysis, especially when a panel of primary antibodies (monoclonal or polyclonal) is needed to accomplish such an assay.

16. The tube of claim 1 can be used alone or in combination with other system(s) to develop various assay systems on either an individual or massive test(s) basis.

17. The tube of claim 1 can be used to prepare sample reagents that can be distributed to potential customers for reagent evaluation.

18. A kit comprising this disposable tube and reagents of an indicator system in pre-aliquot or desiccated form to allow immunological staining of tissue antigen-antigen specific antibody complex.

19. The device of claim 18 wherein said antigen is a constituent of human and mammalian tissue or cells, body fluids, fungi, protozoa, metazoan parasites, bacteria, mycoplasma, or viruses.

20. The kit of claim 18 wherein said indicator is selected from the group consisting of: primary monoclonal or polyclonal antibodies, capable of binding to targeted antigens and form antigen-antibody complexes. Secondary antibody is specific for the species of the primary antibody, such as human, rabbit, goat, mouse et al, and capable of forming antibody-antibody complexes, wherein the secondary antibody is conjugated with an enzyme capable of giving color reaction with a suitable substrate. Substrate is capable to form color under the enzyme reaction. Washing solution that capable of washing out nonspecific bound materials so the background signals can be decreased.
